(19) United States
(12) Patent Application Publication
(10) Pub. No.: US 2025/0180522 A1
(43) Pub. Date: Jun. 5, 2025

(54) NON-INTRUSIVE ULTRASONIC SYSTEM FOR INTERFACE MONITORING IN PRIMARY OIL SEPARATORS

(71) Applicants: PETROLEO BRASILEIRO S. A. - PETROBRAS, Rio de Janeiro (BR); UNIVERSIDADE DE SÃO PAULO - USP, São Paulo (BR)

(72) Inventor: LUIZ OCTAVIO VIEIRA PEREIRA

(73) Assignees: PETRÓLEO BRASILEIRO S. A. - PETROBRAS, Rio de Janeiro (BR); UNIVERSIDADE DE SÃO PAULO - USP, São Paulo (BR)

(21) Appl. No.: 18/968,842

(22) Filed: Dec. 4, 2024

(30) Foreign Application Priority Data
Dec. 5, 2023 (BR) 1020230255574

(51) Int. Cl. G01N 29/44

(52) U.S. Cl. CPC G01N 29/44

(57) ABSTRACT

A system for monitoring fluids in separator vessels is disclosed, comprising a processing unit (1) comprising a signal processor (5) and a display unit (6), and a plurality of pairs of ultrasonic transducers (2) in communication with the signal processor (5). Ultrasonic signals are generated for each pair of transducers, and only the highest intensity captured for each pair is considered. This avoids problems such as multiple reflections on the walls or temperature variations. A graphical representation using the considered signals is provided to aid in the visualization and interpretation of the results.

Thus, an accurate representation of the fluid phases inside the separation vessel is obtained.

### FIELD

This application claims priority to Brazilian Application No. BR 1020230255574, filed on Dec. 5, 2023, the disclosure of which is herein incorporated by reference in the entirety.

The present invention falls within the field of oil engineering. More specifically, the present invention is related to non-intrusive systems and techniques for separating well fluid.

### BACKGROUND

Separator vessels are equipment designed to separate fluids produced in wells and are essential for oil production platforms. Their operation is continuous and an unscheduled shutdown, even for a few hours, generates financial losses in the order of millions of dollars. The measurement of the oil level and oil/water interface is done internally in the vessel. When the measuring equipment stops working, the vessel operation continues without full control of the process, generating the risk of producing unsuitable natural gas and oil and environmental accidents.

The separation of fluids produced in wells is further carried out on offshore oil platforms and is a critical step prior to the transportation of fluids. The production is separated into three components: gas, oil and water. The separation typically occurs in three-phase separators known as gravitational separators. Gas is the least dense material, water is the densest material and oil has an intermediate density. The ideally-complete separation is vital for the specification of fluids for transportation purposes and legal compliance.

The main difficulty of this technique is to obtain an efficient separation between oil and water. This is understandable, since the relative density between oil and water is close to 1. In addition, detection of the oil/water interface is a challenge for existing technologies because it is not fully defined and consists of an emulsion layer. An accurate detection of the phases inside the primary separator provides operational gains (better quality of oil and natural gas) and prevents environmental accidents (discharge of water with non-compliant specifications into the sea).

Due to the critical nature of the initial phase of multiphase separation, several techniques have been developed to measure the oil-water interface level and two ways of installing the meters: in a stand pipe or inside the vessel. The application of meters in pipes outside the vessel, called stand pipe, facilitates maintenance of the devices; however, it does not adequately represent the phenomena that occur inside the separator vessel, has a delayed response and generates a frequent need for cleaning to obtain more reliable readings. The meters installed directly inside the separator vessel have the advantage of performing the measurement with a shorter response time and being able to measure the emulsion layer and the phenomena directly inside the vessel. However, when the meter stops working, the vessel operation continues without full control of the process, leading to the already-mentioned production risks.

Level and interface measurement techniques range from very simple approaches, such as the use of a “sight glass”, floats (displacers) and pressure transducers, to complex multi-source gamma ray systems. The “sight glass” consists of a tempered glass tube connected to the tank wall via valves. Oilfield designs generally include a steel tube fitted with a thick tempered glass window to withstand high pressures and temperatures. As long as the tube is not obstructed and there is no important emulsion layer, the interface level of the sight glass will be close to that inside the tank. The usefulness of the sight glass in primary separation is extremely limited. Impurities in the process fluids quickly coat the inside of the glass, which requires frequent cleaning.

When the meter inside the separator vessel has a problem, the only known technique for measuring the level and interface in a non-intrusive manner to the vessel and without a stand pipe is by means of a radioactive source, a system called neutron backscatter. This solution is generally temporary, since it is performed as a service and not as a product. It is a complex, expensive service and difficult to comply with legal requirements regarding the license to operate with radioactive sources.

The applicability of instruments based on ultrasonic technology to determine variations in the level of liquids contained in tanks and separators in a non-intrusive manner can be limited by multiple reflections on the tank walls and at the interfaces between fluids. The measurement is also sensitive to temperature changes, which requires careful calibration data to be obtained.

### STATE OF THE ART

The paper “Extending the accuracy of ultrasonic level meters” (Olmons, 2002, DOI: 10.1088/0957-0233/13/4/324) discloses a technique based on the application of wave reflection phenomena that occur at the interfaces between phases called guided wave radar. In this technique, the transducer is positioned so as to monitor the vertical direction. This technique measures the oil level well, but is not capable of measuring the oil-water interface.

Patent application EP 2453230A1 relates to the monitored operation of an oil/water separator or other liquid mixture separator. The separator uses a container through which a mixture of different liquid components flows horizontally. A plurality of ultrasound transducers are provided on a wall of the vessel at different heights at a common stage along the horizontal flow direction. A plurality of different ultrasound wavelengths are transmitted through the vessel from the emitting transducers to the receiving transducers. The values of the parameters of a model are adjusted for detection. A model is used that relates the height-dependent properties of the liquid in the container to the properties of the detected ultrasound transmission. The model comprises at least one adjustable parameter of a height-dependent droplet size distribution in at least a subrange of a liquid height in the container. The model relates the droplet size distribution to the ultrasound wavelength dependence of the ultrasound transmission properties. The measured droplet size distribution can be used to determine the route of ultrasound paths and to control demulsification measures. The ultrasound tomograph described in this document is affected by the same problems already described in the previous section.

Publication WO2019009977A1 discloses a system and a method for calibrating the volume of storage containers using ultrasonic inspection techniques. The exemplary ultrasonic calibration system comprises a plurality of acoustic devices deployed in a controlled manner at respective positions on the external surface of the container. The acoustic devices include a transducer for sending acoustic signals through the internal volume of the container and sensors configured to detect the acoustic signals. The acoustic devices are in communication with a diagnostic computing device that controls the positioning and operation of the acoustic devices, and is further configured to determine the time of flight of the acoustic signals traveling between the various acoustic devices. In addition, according to the specific arrangement of the acoustic devices and the information from the measured acoustic signal, the control computer is configured to calculate the dimensions of the container and its internal volume.

### SUMMARY

Several pairs of acoustic transducers are placed on opposite external walls of a vessel to detect the acoustic propagation generated by the same. Several emitter-receiver pairs are defined and the captured signals are analyzed. The acoustic emissions are processed to generate several acoustic profiles to detect the change in position of one or more phases or other characteristics of the industrial process. The maximum amplitude of the captured signal is determined. The results are presented on electronic screens, through matrices that identify a collection of parameters obtained from the processing of the collected signals. These matrices are classified among different types of processing and show a specific view of each of the representation sets of the contents of the vessels or tanks. An analysis of the different views obtained from these states is made to characterize the contents represented by the same. This method minimizes the problems described above, such as multiple reflections on the walls or temperature variations.

### BRIEF DESCRIPTION OF THE DRAWINGS

The present invention will be described below with reference to its typical embodiments and also with reference to the attached drawings, in which:

FIG. 1 is a representation of a fluid separator vessel coupled to the monitoring system and in accordance with the present invention;

FIG. 2 is an alternative representation of a fluid separator vessel coupled to the monitoring system and in accordance with the present invention;

FIG. 3 is a simplified representation of the main modules of the present invention;

FIG. 4 is a more detailed representation of the submodules of the display unit in accordance with the present invention;

FIG. 5 is a more detailed representation of the submodules of the signal processor in accordance with the present invention;

FIG. 6 is a first example of a result obtained with the system in accordance with the present invention;

FIG. 7 is a second example of a result obtained with the system in accordance with the present invention;

FIG. 8 is a third example of a result obtained with the system in accordance with the present invention;

FIG. 9 is a fourth example of a result obtained with the system in accordance with the present invention;

FIG. 10 is a fifth example of a result obtained with the system in accordance with the present invention;

FIG. 11 is a sixth example of a result obtained with the system in accordance with the present invention.

### DETAILED DESCRIPTION OF THE DRAWINGS

Specific embodiments of the present disclosure are described below. In an effort to provide a concise description of these embodiments, all features of an actual implementation may not be described in the specification. It should be appreciated that in the development of any actual implementation, as in any engineering or design project, numerous implementation-specific decisions must be made to achieve the specific objectives of the developers, such as compliance with system-related and business constraints, which may vary from one implementation to another. In addition, it should be appreciated that such a development effort may be complex and time-consuming, but would nevertheless be a routine design and manufacturing undertaking for those of ordinary skill having the benefit of this disclosure.

It is also understood that techniques for emitting and receiving acoustic signals, especially emitting and receiving acoustic signals in the context of monitoring fluids in a separator vessel, are generally known in the state of the art. Accordingly, certain details may be omitted from the description that follows with the understanding that the technician skilled on the subject has prior knowledge to fill these gaps. For example, the specific types of used devices, frequency of the waves, or underlying physical principles may be omitted without impairing the description of the present invention.

A first aspect of the present invention relates to a non-intrusive ultrasonic system for monitoring fluid in a separator vessel. The system, according to a preferred embodiment, has a plurality of emitting and receiving transducers positioned on opposite walls of said vessel.

The vibration mode of the transducers must contain components in the longitudinal mode that transmit acoustic waves through the walls of the separation vessel to which they will be coupled. Other vibration modes may be present in the operation of the transducers, which can be filtered after receiving the ultrasonic waves.

The shape of the transducer face must be designed so that the contact surface between them and the external wall of the separation vessel is maximized taking into account the curvature of the separation vessel, as will be discussed later.

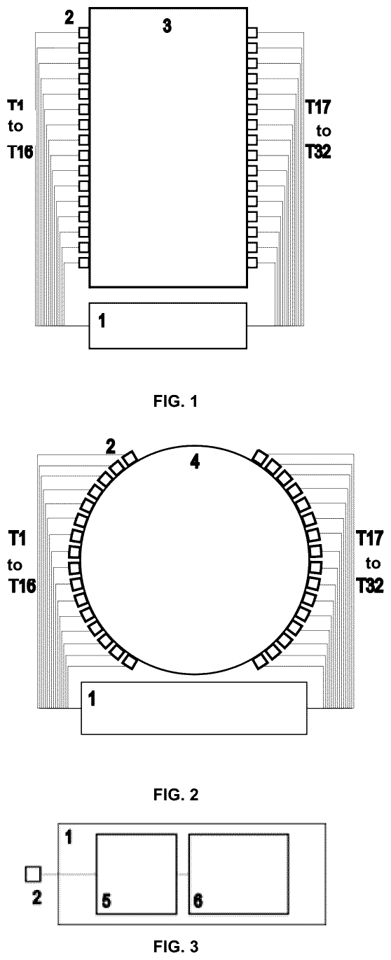

FIG. 1 illustrates an example with 32 transducers, T1 to T16 being emitting transducers and T17 to T32 being receiving transducers, each pair being positioned externally on opposite walls of a vertical vessel 3 and being connected to a processing unit 1. FIG. 2 shows an example with a horizontal vessel 4, again with 32 transducers, T1 to T16 being emitting transducers and T17 to T32 being receiving transducers, positioned externally on opposite walls of the horizontal vessel 4 and being connected to the processing unit 1. The ultrasonic waves are directly applied to the external walls of the vessel 3 or 4 by the emitting transducers T1-T16, transmitting ultrasonic waves that are interfered with by the fluids passing through the interior of the vessel 3 or 4. The present invention makes no distinction between the type of vessel used, although, in specific applications, adjustments may be necessary in view of the dimensions of the vessel being used. However, these adjustments do not depart from the scope of the present invention.

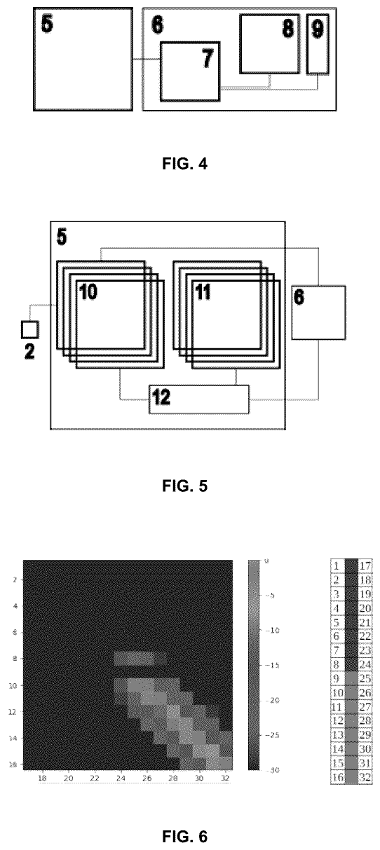

Referring now to FIG. 3, a simplified connection diagram of the elements of the present invention is illustrated. These elements are well known in the art, so it will not be necessary to describe them individually in detail. The processing unit 1 consists of electronics for emitting and receiving ultrasound signals, analysis software and display selector. The electronics must be capable of generating input electrical voltage variations in the form of a pulse or wave pulse train at a frequency that ensures signal detection by the receiver; the frequency range for exciting the transducers 2 is 100 kHz to 1 MHz. The processing unit 1 is directly connected to the emitting transducers 2 (T1-T16), which, when electrically excited, generate ultrasound waves that propagate inside the vessel. The processing unit 1 is also directly connected to the receiving transducers 2 (T17 to T32), which, when hit by the ultrasound waves, generate the electrical signals that are stored by the processing unit 1. The processing unit 1 further comprises a signal processor 5 containing a plurality of multiplexed channels, capable of emitting through any of the emitting transducers 2 and receiving the ultrasound signals through any of the receiving transducers 2. The processing unit 1 further comprises a display unit 6 containing a user interface to enable selection and application of the analysis of geometric parameters. Geometric parameters include the positions of the transducers T1 to T32 along the surface of the external wall of the vessel, in addition to the type of geometry of the vessel.

In FIG. 4, the display unit 6 will be described in more detail. A screen generator 7 enables the reorganization of the data according to the geometric parameters to present the results of the profiling in layers. The screen generator 7 sends data to the matrix electronic screen 8 and to the vector electronic screen 9, which display in full and reduced form, respectively, the maximum amplitude of the signals captured for representation on the matrix electronic screen 8, and the content of the phases for representation on the vector electronic screen 9 (layered profile), displaying the profile of the phases in vessel 3 or 4.

The processing unit 1 sequentially scans the various transducers 2 (emitters and receivers) externally coupled to the walls of vessel 3 or 4, continuously emitting or receiving electrical signals.

Following the example of FIGS. 1 and 2 with 32 transducers, the signal capture begins with the first emitter, T1, and the first receiver, T17. Then, the other receivers T18-T32 receive the signal emitted by the first emitter T1. This process is repeated for all the emitting transducers, scanning all the combinations between emitter and receiver pairs, generating 32×32 captured signals. The captured signals are processed by the signal processor 5, determining the maximum amplitude. These maximum amplitudes are sent to the display unit 6, which, according to the configuration of the screen generator 7, displays the results obtained on the matrix 8 and vector 9 electronic screens.

Although the measurements made of the signal received through the present invention do not depend on the detection of its flight time, its maximum amplitude must be detectable. Therefore, it is necessary to work with longer wavelengths in order to guarantee the propagation energy necessary for its detection on the opposite wall of the vessel. In another aspect, the signal must have a bandwidth wide enough to encompass an ultrasonic frequency response and, ideally, a resonant frequency of the receiving transducer. This resonant frequency can be estimated based on theory.

The processing unit 1 alternately sends and receives electrical signals of duration and shape as described above. Each emitting transducer T1-T16 transforms the electrical signals into ultrasonic waves (pressure variations) and each receiving transducer T17-T32 transforms the captured acoustic waves into electrical signals. For each signal generated by an emitting transducer T1-T16, the signal processor 5 receives the electrical signals captured by the receiving transducers T17-T32 and determines the maximum amplitude of each signal. In other words, the remainder of each signal is discarded, leaving only its maximum amplitude, that is, each receiving transducer T17-T32 will capture several signals with varying amplitudes for each ultrasonic wave emitted by one of the emitting transducers T1-T16, due to the transmission and interaction of the ultrasonic wave inside the vessel. However, as already described above, the signal processor 5 will consider only the largest amplitude of the signal captured by each receiving transducer T17-T32.

Advantageously, the maximum amplitude information is robust to the temperature changes and multiple echoes, avoiding the problems present in the prior art discussed above.

The inventors noted that, in the vicinity of the interface, the signal amplitude is low and may even reach zero. Low amplitudes, therefore, imply proximity to the interface. This interference occurs differently for each set of ultrasonic waves during propagation inside the vessel. More specifically, the interference that occurs due to this spatiotemporal redistribution of the ultrasonic wave can be identified if and only if it is associated with the set or a sufficient subset of maximum amplitudes of the signals. Likewise, any amplitude pattern obtained through the application of the steps of the process described herein will also be subject to this same identification condition. Due to the maintenance of this relation between the amplitude pattern distributed along the dimensions of the matrix and the propagation phenomena inside the vessel, the phase profile will only be obtained by virtue of the entire process described herein.

The signal processor 5 then forwards only the signals that represent the maximum amplitude captured by each of the receiving transducers T17-T32 to the display unit 6. The display unit 6 processes the data obtained by the signal processor 5 through a specialized algorithm managed and defined by the electronic screen generator 7, which will be explained below. Finally, the electronic screen generator 7 organizes the data to be displayed in matrix or vector form by the electronic screens 8 and 9, respectively.

The algorithm executed by the display unit 6 allows profiling through the assimilation of experimental data or by comparison through numerical simulations involving various situations of fluid phase content inside the vessel. These situations can be represented, but are not limited to, by the set of gas, oil, emulsion and water/brine phases in any proportion defined in layers. Matrices M are constructed using the maximum amplitude values captured by the receiving transducers, as previously discussed. A profile c, in vector form, is defined so that each element represents a fluid phase at a given height inside the vessel, as exemplified in equation 1:

$$c = \{ {c}_{1} , {c}_{2} , … , {c}_{n} \} \qquad ( 1 )$$

where cᵢ are the layers of the profile. The process of extracting the profile c is performed by calculating a similarity function f and matrices M given the contents of the phases c, according to equation 2:

$$c = f ( M ) \qquad ( 2 )$$

The matrices M can be of the experimental type (E), obtained from the maximum amplitude signals obtained by transducers 2, or of the simulated type (S), using a numerical model. The model can be among the possible ones that describe acoustic phenomena such as radiation, propagation, diffraction, attenuation and others in 2D media within the limits of the application defined herein. These numerical models are known to the specialist versed in the numerical modeling technique. Below is a non-exhaustive and non-limiting list of numerical methods capable of describing with sufficient precision the phenomena listed above: FSM (fundamental solution method), BEM (boundary element method), FEM (finite element method) and FDM (finite difference method). The similarity function can be determined manually by visual inspection of the experimental matrix or automatically using a similarity generator.

The visual inspection will be described in detail later, and the functionality of the similarity generator will be described below. The similarity generator uses a database created from simulations performed by the numerical model or experimentally obtained, considering specific situations of phase configurations of the medium. Thus, to construct the similarity function f of equation (2), the similarity generator compares the database with the input data without prior knowledge of the phase configurations. The situation in which there is greater similarity in the database will be defined as the phase configurations of the real input data.

If there is energy decay in the signals emitted and captured for each transducer due to variations in transmission energy and mechanical coupling of the transducers to the vessel walls, and due to the assembly features, a gain adjustment process is defined. This process increases the contrast of the image displayed on the matrix screen since its application minimizes eventual errors in amplitudes. The gain adjustment is performed with the aim of improving profiling through the process of extracting the profile of the phases in layers. The gain adjustment process can be repeated whenever the content of the phases c is known and will minimize the dissimilarity between the matrices E and S through a gain adjustment function g and will produce the gain matrix G defined by equation 3:

$$G = g ( E , S ) \qquad ( 3 )$$

Equation (4) shows, through the gain matrix G, how an experimental matrix E can be approximated by a simulated matrix S

$$E + G = S \qquad ( 4 )$$

The gain adjustment G applied to the matrix E, as shown in equation (4), is used to increase the contrast of the image displayed on the electronic matrix screen.

FIG. 5 illustrates signal processor 5 in more detail. As already mentioned, the signal processor 5 receives the signals captured by the receiving transducers T17-T32 and selects only the maximum amplitudes of the signals obtained by all possible pairs of emitting and receiving transducers. The maximum amplitudes of the signals are used to assemble the experimental matrix E and store the same in the experimental database 10. The signal processor 5 also calculates the simulated matrix S by using the numerical model and stores the same in the simulated database 11.

The display unit 6 receives the matrix E and displays the same in graphical form. A similarity generator 12 produces the profile from the content of the phases and matrices, feeding the display unit 6 with vector data of the determined profile c. The gain adjustment process is performed between the experimental database 10 and simulated database 11, producing the gain matrix used by the electronic screen generator in the display of the electronic matrix screen 8.

The signal processor must be configured depending on the number of transducers 2, their positions and the geometry of the separation vessel 3 or 4, see FIGS. 1 and 2. Such configurations are within the knowledge of the technician skilled on the subject, and will therefore not be detailed here.

The composition of the matrix 8 and vector 9 electronic screens, presented by the electronic screen generator 7, is detailed below. The maximum amplitude of each signal is determined and all values are displayed on the matrix electronic screen 8, on the left. The 0-30 color scale is in dB, represented by the logarithm of the value normalized by the maximum value of each matrix. Next, the vector of the layered profile is determined and displayed on the vector electronic screen 9, on the right. The four colors used in the vector of the layered profile represent the fluids: gas, oil, emulsion and water.

FIGS. 6, 7 and 8 illustrate experimental examples of the use of a monitoring system in a vertical vessel according to the electronic screen generator 7.

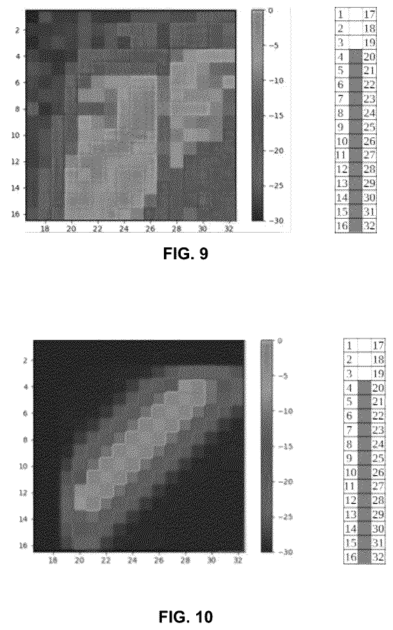

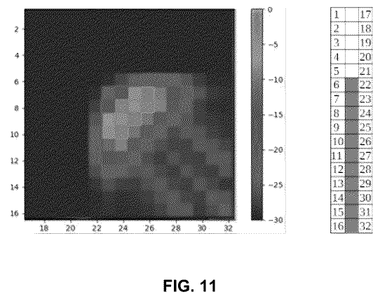

FIG. 9 illustrates an example of the use of a horizontal vessel system. The vessels were open to the atmosphere and their contents remained static. The maximum temperature measured on the external walls of the vertical and horizontal vessels was 60° C. FIGS. 10 and 11 illustrate experimental examples of the use of a system in a horizontal vessel on a reduced scale. In this case, the contents were manipulated through a fluid flow in a quasi-steady regime through a tube inserted inside the same. The experimental examples in FIGS. 10 and 11 were obtained at an ambient temperature of around 20° C.

The assimilation process is discussed based on the understanding of the propagation phenomena inside the vessel. Assimilation is performed by viewing the matrices illustrated in FIGS. 6, 7, 8, 9, 10 and 11 based on knowledge of the configuration of the positions of the transducers 2 and the geometry of separation vessel 3 or 4.

In FIG. 6, representing the vertical vessel, it can be ascertained that the emitting transducers from T1 to T8 and the receiving transducers from T17 to T24 are positioned in the emulsion phase region due to the low captured amplitude. The emitting transducers from T9 to T16 and the receiving transducers from T25 to T32 are positioned in the water phase region because the captured signal has a high amplitude.

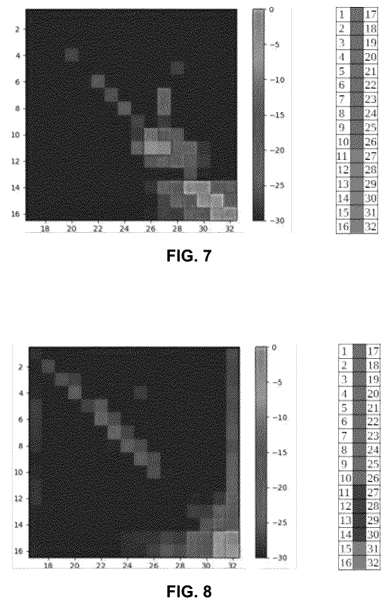

In FIG. 7, representing the vertical vessel, it can be ascertained that the emitting transducers from T1 to T10 and the receiving transducers from T17 to T26 are positioned in the oil phase region based on the intermediate amplitude detected. The emitting transducers from T11 to T16 and the receiving transducers from T27 to T32 are positioned in the water phase region with high amplitude.

In FIG. 8, representing the vertical vessel, it can be ascertained that the emitting transducers from T1 to T10 and the receiving transducers from T17 to T26 are positioned in the oil phase region with intermediate amplitude. The emitting transducers from T11 to T14 and the receiving transducers from T27 to T30 are positioned in the emulsion phase region with low amplitude. The emitting transducers from T15 to T16 and the receiving transducers from T31 to T32 are positioned in the water phase region with high amplitude.

In FIG. 9, representing the horizontal vessel, it can be ascertained that the emitting transducers from T1 to T3 and the receiving transducers from T17 to T19 are positioned in the gas phase region with no amplitude signal. The emitting transducers from T4 to T16 and the receiving transducers from T20 to T32 are positioned in the water phase region with high amplitude.

In FIG. 10, representing the horizontal vessel, it can be ascertained that the emitting transducers from T1 to T2 and the receiving transducers from T17 to T18 are positioned in the gas phase region with no amplitude signal and their interface with the water layer below is partially on the face of the emitting transducer T3 and the receiving transducer T19. In addition, there is a subset of amplitudes that follow an evident alternative pattern in the sequence of the emitting transducers from T4 to T16 and the receiving transducers from T20 to T32. This pattern is presented due to the diffraction of the propagating wave in the water phase between the transducers T4 to T16 and T20 to T32.

In FIG. 11, representing the horizontal vessel, it can be ascertained that the emitting transducers T1 to T5 and the receiving transducers T17 to T21 are positioned in the gas phase region with no amplitude signal and their interface with the water layer below is partially on the face of the emitting transducer T6 and the receiving transducer T22. In the subset of amplitudes between the transducers T7 to T11 and T23 to T27, an alternative pattern is also presented due to the diffraction of the propagating wave in the water phase. In addition, there is another subset of amplitudes that follow an evident alternative pattern in the sequence of the emitting transducers T12 to T16 and the receiving transducers T28 to T32. This pattern is presented due to the reflection of the propagating wave at the interface between the water and gas phases that predominates between the transducers T12 to T16 and from T28 to T32.

The present invention can be applied to vertical and horizontal primary separator vessels for the separation of oil, water and natural gas. The present invention can be used as a redundancy of the conventional measurement internal to the vessel and as a contingency in case of failure of the meter internal to the vessel. The application for vertical and horizontal primary separator tanks has been described.

Although aspects of the present disclosure may be susceptible to various modifications and alternative forms, specific embodiments have been shown by way of example in the drawings and have been described in detail in this document. But it should be understood that the invention is not intended to be limited to the particular forms as disclosed. Rather, the invention should encompass all modifications, equivalents and alternatives that fall within the scope of the invention, as defined by the following appended claims.

1. A system for monitoring fluids in separator vessels, comprising:
a processing unit comprising a signal processor and a display unit;
a plurality of ultrasonic transducers in communication with the signal processor,
wherein the signal processor is configured to store only the maximum amplitudes of the signals among those received from the plurality of ultrasonic transducers.

2. The system according to claim 1, wherein the signal processor further comprises:
an experimental database;
a simulated database; and
a similarity generator with or without gain adjustment for the transducers.

3. The system according to claim 2, wherein the display unit further comprises:
an electronic screen generator;
a matrix electronic screen for displaying the image of maximum amplitudes; and
a vector electronic screen for displaying the profiling in layers.
